(19) United States
(12) Patent Application Publication
(10) Pub. No.: US 2026/0298094 A1
(43) Pub. Date: Oct. 1, 2026

(54) ROTOR FOR A TURBOMACHINE, TURBOMACHINE, AND METHOD FOR BALANCING A ROTOR OF A TURBOMACHINE

(71) Applicant: ACCELLERON SWITZERLAND LTD., Baden (CH)

(72) Inventors: Markus GRAF, Pfatter (DE); Holger FÃTH, Fußgöönheim (DE); Daniel Bernhard RUSCH, Wettingen (CH)

(21) Appl. No.: 19/479,452

(22) PCT Filed: May 7, 2024
(86) PCT No.: PCT/EP2024/062619

§ 371 Date: Oct. 28, 2025

(30) Foreign Application Priority Data
May 11, 2023 (EP) 23172831.2

(51) Int. Cl. F01D 5/02; F04D 29/28; F04D 29/66

(52) U.S. Cl. CPC F01D 5/027; F04D 29/284; F04D 29/662; F05D 2220/40; F05D 2260/15

(57) ABSTRACT

The invention relates to a rotor for a turbomachine. The rotor comprises a rotor nose having an integral balance geometry for material removal for balancing purposes. The balance geometry has a first balance portion having a first center of mass S1 and a second balance portion having a second center of mass S2, wherein the first center of mass S1 and the second center of mass S2 are mutually axial spaced. The invention also relates to a turbomachine having a rotor of this kind, and to a method for balancing a rotating assembly of a turbomachine having a rotor. According to an alternative embodiment, the balance geometry has an outer surface for a first material-removal process and an inner surface for a second material-removal process for balancing purposes. The outer surface has a greater radial distance from an axis of rotation of the rotor than the inner surface.

### TECHNICAL FIELD

The invention relates to the field of turbomachines, in particular the rotors for turbomachines, and to the field of balancing, in particular the balancing of rotors and rotating assemblies of turbomachines.

### TECHNICAL BACKGROUND

Exhaust gas turbochargers are nowadays used as standard to boost the power of an internal combustion engine, having a turbine in the exhaust tract of the internal combustion engine and having a compressor arranged ahead of the internal combustion engine. Here, the exhaust gases of the internal combustion engine are expanded in the turbine. The work obtained during this process is transferred by means of a shaft to the compressor, which compresses the air fed to the internal combustion engine. By using the energy of the exhaust gases to compress the air fed to the combustion process in the internal combustion engine, it is possible to optimize the combustion process and the efficiency of the internal combustion engine.

Exhaust gas turbochargers consist essentially of a turbine wheel and a compressor wheel, wherein the turbine wheel is welded to a shaft, after which the compressor wheel is secured on the opposite end.

Owing to the dimensional deviations and deviations in material joints that inevitably occur in the production processes, there are deviations in mass with respect to the rotor axis, which, as a combination of a static unbalance and a torque unbalance, are referred to as dynamic unbalance. Additional instances of unbalance arise during the subsequent assembly process for the turbine rotor and during assembly of the core assembly owing to the additional individual parts susceptible to unbalance that are fitted on, the dimensional, position and fit tolerances, and also on account of any instances of plastification in the shaft-assembly and shaft thread.

During operation, i.e. during rotation of the rotor, these instances of unbalance lead to revolving centrifugal forces which, in the ideal case for rotors with rigid behavior, increase with the square of the speed of revolution. For rotors with elastic-shaft behavior, excitation can lead to the eigenform critical in terms of bending, which in turn leads to high forces that stress the bearing system. In order to avoid exceeding the maximum bearing load capacity under all operating conditions and thus to ensure the envisaged service life of the turbochargers, these are tested for unbalance in what is generally a multi-stage process and, if necessary, mass balancing is carried out until the previously defined limits are satisfied.

The balancing process is simpler for compressor wheels than for turbine wheels since, by virtue of a simpler manufacturing process, these are less subject to unbalance, and the material can be machined with less tool wear. It may also be possible to install compressor wheels on the turbocharger without separate balancing of individual parts.

In the case of the turbine rotors, the unbalance results almost completely from the welded-on turbine wheel, and, as a result, balancing is unavoidable because of the large dimensional deviations in the unmachined workpieces. To reduce the initial instances of unbalance, balance centering methods are often also applied in machining turbine wheels in order to reduce expenses involved in rotor balancing and also to keep the geometric balancing allowance within limits.

To compensate for instances of dynamic unbalance, two compensating planes at a sufficient axial distance from one another are generally required. For this purpose, the “nose planes” are used in combination with the respective wheel-disk or wheel-back plane. Either before or after assembly of the core assembly, the rotating assembly is checked for unbalance, and, insofar as required, the material removal is carried out in at least one but at most two additional compensating planes.

In sum, up to six compensating planes may be required for a turbocharger or for the rotating assembly of a turbocharger, and these must be taken into account in the design of the turbocharger. This requires appropriate consideration in the design phase of a turbocharger as regards the rotor dynamics, thermodynamics, wheel strength and industrialization, to name just a few.

In the off-road utility vehicle sector and for applications in stationary continuous-flow machines, power station generators or motors in the maritime sector, turbochargers are balanced in manual processes on account of their size and weight and the small numbers involved. Among the articles developed for this purpose are compressor wheels that have a plurality of threaded holes which are provided in a ring shape around the center on the nose geometry and in which one or more balance weights of the same or different length and mass can be screwed, depending on the magnitude of the unbalance.

In the geometric design of the wheels, for reasons of producibility, surfaces for retention and possibilities for torque transfer must be reserved in addition to the regions for balancing compensation, irrespective of the type of unbalance compensation. Since, in turbochargers, the turbine wheel and the compressor wheel are connected to one another via the shaft, relative displacement or even rotational twisting relative to one another should be prevented under all circumstances in order to prevent both shaft torsion and unbalance changes. This has led to compressor wheels being secured on the shaft either via a shaft nut as a drilled variant or via the wheel itself as a screwed variant. During this process, additional small parts, e.g. a bearing collar, an oil deflector ring and a sealing bush, are furthermore fixed in the shaft assembly.

The geometries of the wheel noses must thus generally perform at least one of these dual functions, which is not a problem as long as these are harmonized with one another or are completed successively in terms of manufacture without subsequent impairment occurring. However, if the intention is to compensate material or mass in one and the same plane or axial position on the wheel or rotating assembly in a successive balancing process, this is significantly more difficult since it is no longer possible to machine these independently of one another.

It is therefore an object of the present invention to provide a rotor and a balancing method by means of which one or more of the disadvantages known from the prior art can be partially or completely overcome.

### BRIEF DESCRIPTION OF THE INVENTION

To achieve the abovementioned object, a rotor, a turbomachine and a method for balancing a rotating assembly as claimed in the independent claims are provided. Further aspects, advantages and features of the present invention can be found in the dependent patent claims, the description and the accompanying figures.

According to one aspect of the invention, a rotor for a turbomachine is provided. The rotor comprises a rotor nose having an integral balancing geometry for material removal for the purpose of balancing. The balancing geometry has a first balancing portion having a first center of mass and a second balancing portion having a second center of mass. The first center of mass and the second center of mass are spaced apart axially. A maximum radial extent of the first balancing portion is less than a maximum radial extent of the second balancing portion. The first balancing portion has an axial end surface for axial material removal for the purpose of balancing the rotor as an individual part. The second balancing portion has an axial end surface for axial material removal for the purpose of balancing a rotating assembly of a turbomachine having the rotor.

Thus, a rotor is advantageously provided which is improved relative to the prior art in respect of balancing. In particular, a rotor having a balancing geometry in accordance with the embodiments described herein advantageously enables balancing of the rotor as an individual part and in the combined rotating assembly by means of material removal at the balancing geometry, with the result that balancing removal at the wheel disk or in the hub contour between the blades is no longer necessary. Another advantage of the rotor having a balancing geometry with a balancing geometry in accordance with the embodiments described herein is that simple drilling tools and fixtures can be used, which allow precise infeed and thus enable a significant reduction in manual inaccuracies and the number of iteration steps required. In sum, this generates a cost advantage in turbocharger production and increases the quality of unbalance compensation.

According to a second aspect of the invention, a rotor for a turbomachine is provided. The rotor comprises a rotor nose having an integral balancing geometry for material removal for the purpose of balancing. The balancing geometry has an outer surface for a first material removal for the purpose of balancing, in particular for balancing the rotor as an individual part. The balancing geometry furthermore has an inner surface for a second material removal for the purpose of balancing, in particular for balancing a rotating assembly of a turbomachine having the rotor. The outer surface is at a greater radial distance from an axis of rotation of the rotor than the inner surface.

According to a third aspect of the invention, a turbomachine, in particular a turbocharger, having a rotor in accordance with one of the embodiments described herein is provided.

According to a fourth aspect of the invention, a method for balancing a rotating assembly of a turbomachine having a rotor is provided. The method comprises measuring an unbalance of the rotor as an individual part. The rotor has a balancing geometry which is an integral component of a rotor nose of the rotor. The balancing geometry has a first balancing portion having a first center of mass. In addition, the balancing geometry has a second balancing portion having a second center of mass. The first center of mass and the second center of mass are spaced apart axially. A maximum radial extent of the first balancing portion is less than a maximum radial extent of the second balancing portion. Moreover, the method comprises balancing the rotor as an individual part by a first removal of material at a first location on the first balancing portion. Alternatively, the method can comprise balancing the rotor as an individual part by a first removal of material at a first location on the second balancing portion. In addition, the method comprises assembling the rotating assembly with the rotor balanced as an individual part. Moreover, the method comprises measuring an unbalance of the rotating assembly. In addition, the method comprises balancing the rotating assembly by a second removal of material at a second location on the second balancing portion, wherein the second location on the second balancing portion is spaced apart axially and/or radially from the first location. Alternatively, the method comprises balancing the rotating assembly by a second removal of material at a second location on the first balancing portion, wherein the second location on the first balancing portion is spaced apart axially and/or radially from the first location on the second balancing portion.

According to a fifth aspect of the invention, a method for balancing a rotating assembly of a turbomachine having a rotor is provided. The method comprises measuring an unbalance of the rotor as an individual part. The rotor comprises a rotor nose having an integral balancing geometry for material removal for the purpose of balancing. The balancing geometry has an outer surface for a first material removal for the purpose of balancing the rotor as an individual part. The balancing geometry furthermore has an inner surface for a second material removal for the purpose of balancing a rotating assembly of a turbomachine having the rotor. The outer surface is at a greater radial distance from an axis of rotation of the rotor than the inner surface. In other words, the outer surface is typically a radially outer surface of the balancing geometry. The inner surface is typically a radially inner surface of the balancing geometry. Moreover, the method comprises balancing the rotor as an individual part by a first removal of material at a first location on the outer surface. Alternatively, balancing the rotor as an individual part can also be accomplished by a first removal of material at a first location on the inner surface. In addition, the method comprises assembling the rotating assembly with the rotor balanced as an individual part. Moreover, the method comprises measuring an unbalance of the rotating assembly. In addition, the method comprises balancing the rotating assembly by a second removal of material at a second location on the inner surface, in particular wherein the second location is spaced apart axially from the first location. Alternatively, balancing the rotating assembly can also be accomplished by a second removal of material at a second location on the outer surface.

### BRIEF DESCRIPTION OF THE FIGURES

The invention will be explained below with reference to exemplary embodiments, which are illustrated in the figures and from which further advantages and modifications can be derived. Here:

FIG. 1 shows a schematic sectional view of a rotor according to embodiments described herein;

FIG. 2 shows a schematic perspective view of a balancing geometry according to embodiments described herein;

FIGS. 3 and 4 show schematic perspective views of balancing geometries with illustrative material removals according to embodiments described herein;

FIGS. 5A-5C show illustrative embodiments of axial material removals by means of implemented drilling geometries;

FIG. 6 shows a schematic perspective view of a balancing geometry with illustrative material removals according to other embodiments described herein;

FIG. 7 shows a schematic sectional view of a rotor having an alternative balancing geometry according to embodiments described herein;

FIG. 8 shows a schematic sectional view of a rotating assembly of a turbomachine according to embodiments described herein; and

FIG. 9 shows a block diagram to illustrate a method for balancing a turbocharger rotating assembly having a rotor in accordance with embodiments described herein.

### DETAILED DESCRIPTION OF THE FIGURES

Various embodiments, of which one or more examples are illustrated in each image, are described below. Each example is used for explanation and is not to be interpreted as restrictive. For example, features which are illustrated or described as part of one embodiment can be used on or in combination with any other embodiment to obtain another embodiment. The intention is that the present disclosure should include such modifications and variations.

In the following description of the figures, the same reference numbers refer to the same or similar components. In general, only the differences in respect of the individual embodiments are described. Unless otherwise stated, the description of a part or aspect in one embodiment can also refer to a corresponding part or a corresponding aspect in another embodiment.

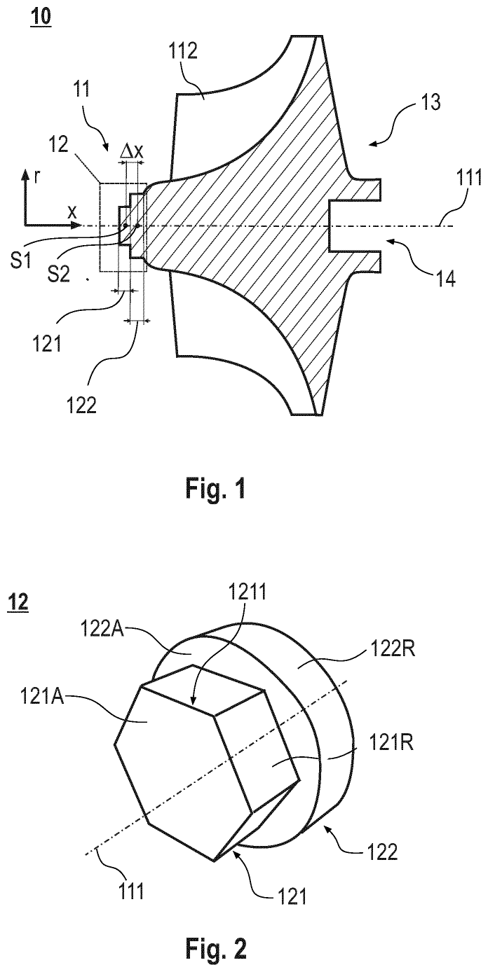

A rotor 10 according to the present disclosure is described with reference to FIGS. 1 to 7. For example, the rotor 10 can be a turbine wheel or a compressor wheel. According to one embodiment, which can be combined with other embodiments described herein, the rotor 10 comprises a rotor nose 11 having an integral balancing geometry 12 for material removal for the purpose of balancing. The balancing geometry 12 has a first balancing portion 121 having a first center of mass S1 and a second balancing portion 122 having a second center of mass S2. The first center of mass S1 and the second center of mass S2 are spaced apart axially.

Thus, a rotor having an integrated balancing geometry is advantageously provided which enables balancing as an individual part in two planes and also subsequent balancing on the rotating assembly in an economical manner, with high precision of the balancing, in a manual or semiautomated process. In the case of individual part balancing, it is possible, for example, to use the first balancing portion 121 and/or the second balancing portion 122 for material removal and, for further material removal, additionally to use a balancing plane in the region of the rotor rear wall and/or a region at the rotor outlet, with the result that individual part balancing typically takes place in two planes.

It should be noted that the first center of mass S1 and the second center of mass S2 may additionally be spaced apart radially, e.g. on account of manufacturing tolerances. The axial direction x, the radial direction r and the axial spacing Δx between the first center of mass S1 and the second center of mass S2 have been entered by way of example in FIG. 1. After a balancing material removal at the first balancing portion 121 and/or the second balancing portion 122, the first center of mass S1 and the second center of mass S2 may be spaced apart axially and radially.

In the present disclosure, a “balancing geometry” can be understood to mean a specific geometry of a rotor region, in particular the rotor nose, which makes it possible to balance the rotor by material removal at certain locations of the balancing geometry. This is therefore a geometry which is designed specifically for the purpose of balancing and is part of the rotor.

In the present disclosure, a “rotor nose” can be understood to mean the front part of the rotor. In the context of a turbocharger rotor, e.g. a compressor wheel or turbine wheel, the rotor nose refers to the front part of the rotor, which is situated closest to the inlet or outlet region of the turbocharger.

In the present disclosure, a “balancing portion” can be understood to mean a region of the balancing geometry in which material is removed in order to balance the rotor or a rotating assembly comprising the rotor. This is a specific part of the balancing geometry which is designed to meet the requirements of balancing and at which material is removed in order to ensure uniform distribution of the masses and correct rotation of the rotor or rotating assembly. The terms “first balancing portion” and “second balancing portion” can be understood as separate balancing portions. In other words, there is typically no overlap between the first balancing portion and the second balancing portion.

According to one embodiment, which can be combined with other embodiments described herein, a maximum radial extent R₁ₘₐₓ of the first balancing portion 121 is less than a maximum radial extent R₂ₘₐₓ of the second balancing portion 122.

According to one embodiment, which can be combined with other embodiments described herein, the first balancing portion 121 has an axial end surface 121A for axial material removal for the purpose of balancing. As an alternative or in addition, the first balancing portion 121 has a radial surface 121R for radial material removal for the purpose of balancing.

In the present disclosure, an “axial surface” can be understood to mean a surface which has a surface normal in a substantially axial direction. A “substantially axial direction” can be understood to mean a direction which can deviate from the exact axial direction within a tolerance range. For example, the substantially axial direction can be a direction which deviates from the exact axial direction x within a tolerance range of less than ±40°, in particular less than ±25° and, even more specifically, less than ±15°. A “radial surface” can be understood to mean a surface which has a surface normal in a substantially radial direction. A “substantially radial direction” can be understood to mean a direction which can deviate from the exact radial direction within a tolerance range. For example, the substantially radial direction can be a direction which deviates from the exact radial direction r within a tolerance range of less than ±40°, in particular less than ±25° and, even more specifically, less than ±15°.

According to one embodiment, which can be combined with other embodiments described herein, the second balancing portion 122 has an axial end surface 122A for axial material removal for the purpose of balancing. As an alternative or in addition, the second balancing portion 122 has a radial surface 122R for radial material removal for the purpose of balancing.

According to one embodiment, which can be combined with other embodiments described herein, the first balancing portion 121 has an outer contour 1211 adapted for an assembly tool, as illustrated by way of example in FIG. 2. As an alternative, the first balancing portion 121 can have an inner contour 1212 adapted for an assembly tool, as illustrated by way of example in FIG. 6.

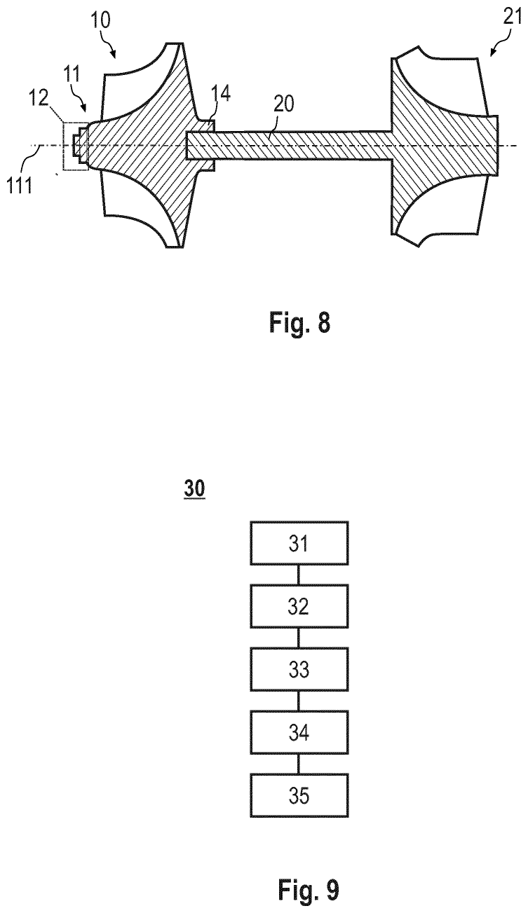

According to one embodiment, which can be combined with other embodiments described herein, a rotor rear side 13 has a centrally arranged connecting element 14 for connection to a shaft 20, as illustrated by way of example in FIGS. 1 and 8. In particular, the centrally arranged connecting element 14 can be a blind hole with an internal thread, e.g. a three-start internal thread. Alternatively, the centrally arranged connecting element can be a stub, e.g. a stub with an external thread, in particular a three-start external thread. Alternatively, the connecting element 14 can be without a thread and can be connected to the shaft by means of a welded joint, in particular a friction welded joint.

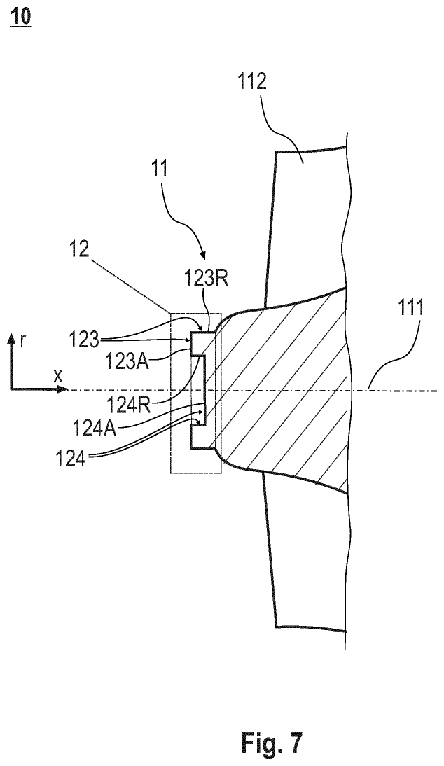

A rotor 10 comprising a further variant of the balancing geometry 20 is described with reference to FIG. 7. According to one embodiment, which can be combined with other embodiments described herein, the rotor 10 comprises a rotor nose 11 having an integral balancing geometry 12 for material removal for the purpose of balancing. As illustrated by way of example in FIG. 7, the balancing geometry 12 has an outer surface 123 for a first material removal for the purpose of balancing. In addition, the balancing geometry 12 has an inner surface 124 for a second material removal for the purpose of balancing. As shown in FIG. 7, the outer surface 123 is at a greater radial distance from an axis of rotation 111 of the rotor 10 than the inner surface 124.

In the present disclosure, an “outer surface” can be understood to mean the outer surface of the balancing geometry. In particular, the outer surface is the surface which faces outward. An “inner surface” can be understood to mean a surface of the balancing geometry which faces inward. Typically, the inner surface of the balancing geometry is not visible from the outside when viewed from the side since it is situated within the balancing geometry.

As illustrated by way of example in FIG. 7, the outer surface 123 of the balancing geometry 12 typically comprises an outward-facing axial surface 123A and an outward-facing radial surface 123R. The inner surface 124 of the balancing geometry 12 typically comprises an inward-facing radial surface 124R and an axial surface 124A arranged within the balancing geometry.

It is self-evident that, by using a rotor 10 according to one of the embodiments described herein in a turbomachine, e.g. in a turbocharger, an improved turbomachine, in particular an improved turbocharger, can be provided.

Accordingly, the turbomachine typically comprises a rotor having a balancing geometry 12 which involves at least one material removal. In particular, the material removal can be performed on one or more of the following surfaces: an axial end surface 121A of the first balancing portion 121, a radial surface 121R of the first balancing portion 121, an axial end surface 122A of the second balancing portion 122, a radial surface 122R of the second balancing portion 122, a radial surface 123R of an outer surface 123, an axial surface 123A of an outer surface 123, an axial surface 124A of an inner surface 124, and a radial surface 124R of an inner surface 124.

With reference to the block diagram in FIG. 9, a method 30 for balancing a rotating assembly of a turbomachine having a rotor 10 according to the present disclosure is described. FIG. 8 shows a schematic sectional view of a rotating assembly of a turbocharger, wherein the rotor 10 is a compressor wheel, which is connected to a turbine wheel 21 by means of a shaft 20.

According to one embodiment, which can be combined with other embodiments described herein, the method 30 comprises measuring (illustrated schematically by block 31 in FIG. 9) an unbalance of the rotor 10 as an individual part. Furthermore, the method comprises balancing (illustrated schematically by block 32 in FIG. 9) of the rotor as an individual part by a first removal of material at a first location on a balancing geometry, which is an integral component of a rotor nose of the rotor. In addition, the method comprises assembling (illustrated schematically by block 33 in FIG. 9) the rotating assembly with the rotor balanced as an individual part. Moreover, the method comprises measuring (illustrated schematically by block 34 in FIG. 9) an unbalance of the rotating assembly. In addition, the method comprises balancing (illustrated schematically by block 35 in FIG. 9) the rotating assembly by a second removal of material at a second location on the balancing geometry, wherein the second location is spaced apart axially and/or radially from the first location.

According to one embodiment, which can be combined with other embodiments described herein, the rotor in the method 30 is a rotor according to one of the embodiments described herein. The first location for removing material for the purpose of balancing the rotor 10 as an individual part can be situated on the second balancing portion 122, and the second location for removing material for the purpose of balancing the rotating assembly can be situated on the first balancing portion 121. Alternatively, the first location for removing material for the purpose of balancing the rotor 10 as an individual part can be situated on the first balancing portion 121, and the second location for removing material for the purpose of balancing the rotating assembly can be situated on the second balancing portion 122.

In connection with the alternative variant illustrated in FIG. 7, it should be noted that the first location for removing material for the purpose of balancing the rotor 10 as an individual part can be situated on the outer surface 123, and the second location for removing material for the purpose of balancing the rotating assembly can be situated on the inner surface 124. Alternatively, the first location for removing material for the purpose of balancing the rotor 10 as an individual part can be situated on the inner surface 124, and the second location for removing material for the purpose of balancing the rotating assembly can be situated on the outer surface 123.

According to one embodiment, which can be combined with other embodiments described herein, the removal of material for the balancing of the rotor as an individual part can take place at a radial surface 122R and/or axial surface 122A of the second balancing portion 122. The removal of material for the purpose of balancing the rotating assembly can take place at an axial end surface 121A and/or at a radial surface 121R of the first balancing portion 121. Alternatively, the removal of material for the purpose of balancing the rotor as an individual part can take place at an axial end surface 121A and/or at a radial surface 121R of the first balancing portion 121. It is likewise possible, as an alternative, for the removal of material for the purpose of balancing the rotating assembly to take place at a radial surface 122R and/or axial surface 122A of the second balancing portion 122.

In connection with the alternative variant illustrated in FIG. 7, it should be noted that the removal of material for the purpose of balancing the rotor as an individual part can take place at the radial surface 123R and/or the axial surface 123A of the outer surface 123. The removal of material for the purpose of balancing the rotating assembly can take place at an axial surface 124A and/or at a radial surface 124R of the inner surface 124. Alternatively, the removal of material for the purpose of balancing the rotor as an individual part can take place at the radial surface 124R and/or the axial surface 121A of the inner surface 124. It is likewise possible, as an alternative, for the removal of material for the purpose of balancing the rotating assembly to take place at the radial surface 123R and/or the axial surface 123A of the outer surface 123.

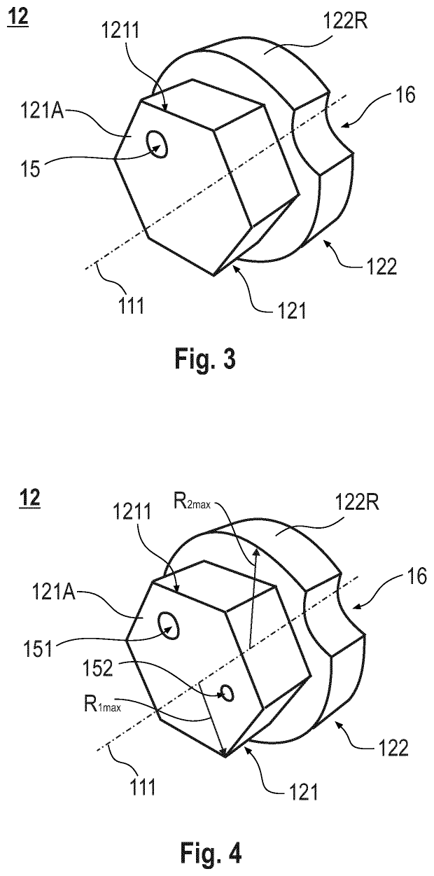

The removal of material at the axial end surface 121A and/or the radial surface 121R of the first balancing portion 121 can be accomplished by implementing at least one drilling geometry 15. The removal of material at a radial surface 122R and/or axial surface 122A of the second balancing portion 122 can likewise be accomplished by implementing at least one drilling geometry. A drilling geometry 15 in the axial end surface 121A is illustrated by way of example in FIG. 3. FIG. 4 shows an example with a first drilling geometry 151 and a second drilling geometry, which were each implemented in the axial end surface 121A. Radial material removals 16 are furthermore illustrated by way of example in FIGS. 3, 4 and 6. The removal of material can be accomplished by drilling, milling or other mechanical material removal methods, for example.

In connection with the alternative variant illustrated in FIG. 7, it should be noted that the removal of material at the axial surface 123A and/or the radial surface 123R of the outer surface 123 are/is accomplished by implementing at least one drilling geometry 15. The removal of material at a radial surface 124R and/or axial surface 124A of the inner surface 124 can likewise be accomplished by implementing at least one drilling geometry. It should furthermore be noted that the removal of material at the axial surface 123A and/or the radial surface 123R of the outer surface 123 can be accomplished by milling. The removal of material at a radial surface 124R and/or axial surface 124A of the inner surface 124 can likewise be accomplished by milling.

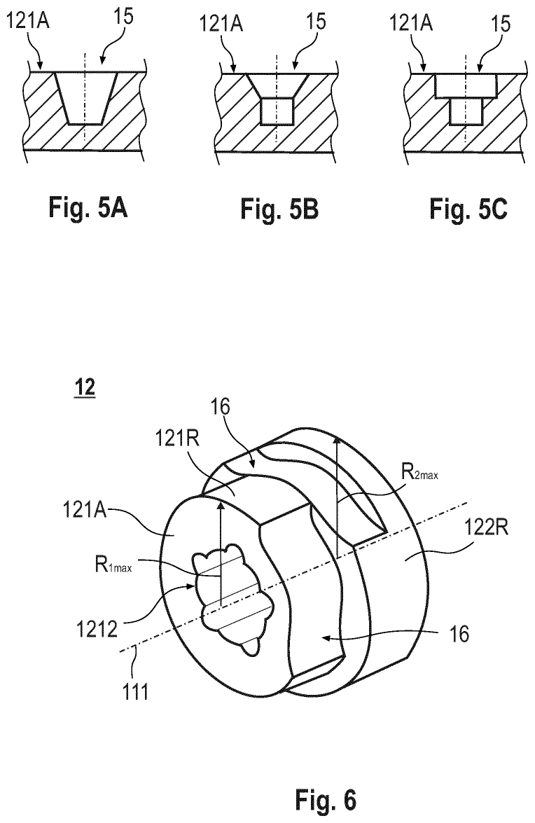

The drilling geometry can be of cylindrical design (not illustrated explicitly) or of conical design (see FIG. 5A). Furthermore, the drilling geometry can be implemented with a cylindrical recess (see FIG. 5C) or a conical recess (see FIG. 5B). It is self-evident that the drilling geometry can also have other contours.

As is apparent from the embodiments described herein, a rotor and a balancing method which are improved over the prior art are advantageously provided according to the invention. Through the use of a rotor having a balancing geometry according to the embodiments described, the rotor can be balanced more effectively, both as an individual part and in the overall rotating assembly system by removing material from the balancing geometry. This eliminates the need for a balancing removal on the wheel disk or in the hub contour between the blades. Another advantage of this balancing geometry is that simple drilling tools and fixtures can be used to enable precise infeed. Furthermore, balancing drilling geometries can be of conical configuration, reducing the risk of unwanted material accumulations and facilitating another balancing removal at an identical or adjacent location when required. This considerably reduces manual inaccuracies and the number of iteration steps required, leading to cost savings in the production of turbochargers and improving the quality of the unbalance compensation.

### LIST OF REFERENCE SIGNS

10 rotor
11 rotor nose
111 axis of rotation
112 blade
12 balancing geometry
121 first balancing portion
121A axial end surface of the first balancing portion for axial material removal
121R radial surface of the first balancing portion for radial material removal
1211 outer contour, adapted for assembly tool, of the first balancing geometry
1212 inner contour, adapted for assembly tool, of the first balancing portion
122 second balancing portion
122A axial end surface
122R radial surface of the second balancing portion for radial material removal
123 outer surface of the balancing geometry
123A axial surface of the outer surface
123R radial surface of the outer surface
124 inner surface of the balancing geometry
124A axial surface of the inner surface
124R radial surface of the inner surface
13 rotor rear side
14 connecting element
15 drilling geometry
151 first drilling geometry
152 second drilling geometry
16 radial material removal
20 shaft
21 turbine wheel
S1 first center of mass
S2 second center of mass
30 method for balancing a rotating assembly having a rotor
31-35 blocks of the block diagram for the purpose of illustrating method steps of the method for balancing

1-15. (canceled)

16. A rotor for a turbomachine, comprising a rotor nose having an integral balancing geometry for material removal for the purpose of balancing, wherein the balancing geometry has a first balancing portion having a first center of mass S1 and a second balancing portion having a second center of mass S2, wherein the first center of mass S1 and the second center of mass S2 are spaced apart axially, wherein a maximum radial extent R₁ₘₐₓ of the first balancing portion is less than a maximum radial extent R₂ₘₐₓ of the second balancing portion,
wherein the first balancing portion has an axial end surface for axial material removal for the purpose of balancing the rotor as an individual part, and
wherein the second balancing portion has an axial end surface for axial material removal for the purpose of balancing a rotating assembly of a turbomachine having the rotor.

17. The rotor as claimed in claim 16, wherein the first balancing portion furthermore has a radial surface for radial material removal for the purpose of balancing.

18. The rotor as claimed in claim 16, wherein the second balancing portion furthermore has a radial surface for radial material removal for the purpose of balancing.

19. The rotor as claimed in in claim 16, wherein the first balancing portion has an outer contour or inner contour adapted for an assembly tool.

20. The rotor as claimed in claim 16, wherein a rotor rear side has a centrally arranged connecting element for connection to a shaft.

21. The rotor of claim 20, wherein the centrally arranged connecting element is a blind hole with an internal thread.

22. The rotor of claim 20, wherein the centrally arranged connecting element is a stub with an external thread.

23. The rotor as claimed in claim 16, wherein the rotor is a compressor wheel or a turbine wheel.

24. A rotor for a turbomachine, comprising a rotor nose having an integral balancing geometry for material removal for the purpose of balancing, wherein the balancing geometry has an outer surface for a first material removal for the purpose of balancing, and wherein the balancing geometry has an inner surface for a second material removal for the purpose of balancing, wherein the outer surface is at a greater radial distance from an axis of rotation of the rotor than the inner surface.

25. A method for balancing a rotating assembly of a turbomachine having a rotor, comprising:
measuring an unbalance of the rotor as an individual part, wherein the rotor has a balancing geometry, which is an integral component of a rotor nose of the rotor, wherein the balancing geometry has a first balancing portion having a first center of mass S1 and a second balancing portion having a second center of mass S2, wherein the first center of mass S1 and the second center of mass S2 are spaced apart axially, wherein a maximum radial extent R₁ₘₐₓ of the first balancing portion is less than a maximum radial extent R₂ₘₐₓ of the second balancing portion,
balancing the rotor as an individual part by a first removal of material at a first location on the first balancing portion,
assembling the rotating assembly with the rotor balanced as an individual part,
measuring an unbalance of the rotating assembly, and
balancing the rotating assembly by a second removal of material at a second location on the second balancing portion, wherein the second location is spaced apart axially and/or radially from the first location.

26. The method as claimed in claim 25, wherein the rotor comprises a rotor nose having an integral balancing geometry for material removal for the purpose of balancing, wherein the balancing geometry has a first balancing portion having a first center of mass and a second balancing portion having a second center of mass, wherein the first center of mass and the second center of mass are spaced apart axially, wherein a maximum radial extent R₁ₘₐₓ of the first balancing portion is less than a maximum radial extent R₂ₘₐₓ of the second balancing portion,
wherein the first balancing portion has an axial end surface for axial material removal for the purpose of balancing the rotor as an individual part, and
wherein the second balancing portion has an axial end surface for axial material removal for the purpose of balancing a rotating assembly the turbomachine, wherein the first location for removing material for the purpose of balancing the rotor as an individual part is situated on the second balancing portion, and wherein the second location for removing material for the purpose of balancing the rotating assembly is situated on the first balancing portion, or vice versa.

27. The method as claimed in claim 26, wherein the removal of material for the purpose of balancing the rotor as an individual part takes place at a radial surface and/or axial surface of the second balancing portion, and wherein the removal of material for the purpose of balancing the rotating assembly takes place at an axial end surface and/or at a radial surface of the first balancing portion, or vice versa.

28. The method as claimed in claim 27, wherein the removal of material at the axial end surface and/or a radial surface of the first balancing portion is accomplished by implementing at least one drilling geometry.

29. The method as claimed in claim 28, wherein the at least one drilling geometry is of cylindrical or conical design, or wherein the at least one drilling geometry is implemented with a cylindrical or conical recess.

30. The method of claim 25, wherein the balancing geometry has an outer surface for the first material removal for the purpose of balancing the rotor as an individual part, wherein the balancing geometry furthermore has an inner surface for the second material removal for the purpose of balancing a rotating assembly of a turbomachine having the rotor, wherein the outer surface is at a greater radial distance from an axis of rotation of the rotor than the inner surface.
